(19) United States
(12) Patent Application Publication
(10) Pub. No.: US 2023/0166217 A1
(43) Pub. Date: Jun. 1, 2023

(54) PLEATED COMPOSITE PERVAPORATION LAMINATE AND METHOD OF MAKING SAME

(71) Applicant: FFI IONIX IP, INC., Wilmington, DE (US)

(72) Inventors: Sai Nitin Yellamilli, Naperville, IL (US); Dominick Bindl, Middleton, WI (US); Abhishek Bandlore, Milford, DE (US); Bamdad Bahar, Georgetown, DE (US)

(21) Appl. No.: 18/073,529

(22) Filed: Dec. 1, 2022

Related U.S. Application Data
(60) Provisional application No. 63/285,001, filed on Dec. 1, 2021.

(51) Int. Cl. B01D 63/14; B01D 67/00; B01D 69/10; B01D 71/56

(52) U.S. Cl. CPC B01D 63/14; B01D 67/0013; B01D 67/0086; B01D 69/107; B01D 71/56; B01D 2323/50; B01D 2323/64; B01D 2325/02832; B01D 2325/04

(57) ABSTRACT

A composite pervaporation laminate incorporates a thin hydrophilic film laminated on a formable macroporous support layer. The method for making the membrane involves solution casting a thin film on a carrier substrate and transferring the said film onto a macroporous support by hot pressing, such as by decal transfer. Ultra-thin defect-free film, such as less than 5 micrometers, are laminated using this method to achieve very high-water transmission rates and very low or zero gas permeation. The membrane can then be formed into a three-dimensional structure by pleating or corrugating to increase the surface area. The membrane can be used as spacers in an ERV application.

### CROSS REFERENCE TO RELATED APPLICATIONS

This application claims the benefit of priority to U.S. provisional patent application No. 63/285,001, filed on Dec. 1, 2021; the entirety of which is hereby incorporated by reference herein.

### BACKGROUND OF THE INVENTION

The invention relates to relates to water vapor transport membranes comprising highly selective films and porous supports. Such membranes are particularly suitable for use in enthalpy exchangers and other applications involving exchange of moisture and optionally heat between gas streams, with little or no mixing of the gas streams through the membrane.

### BACKGROUND

Devices that exchange moisture between the two air streams are generally referred to as Energy Recovery Ventilators (ERV), sometimes also referred to as Enthalpy Recovery Ventilators or enthalpy exchangers.

For buildings to have good indoor air quality they require an exchange of the stale indoor air with fresh outdoor air. An ERV can be used for this purpose, and incorporates a method to remove excess humidity from, or add humidity to, the ventilating air that is being brought into a building. In addition to improving indoor air quality in buildings, installation of an ERV will result in energy savings. For example, in hot and humid climates, useable energy is wasted when the cooled air from the building is exhausted. In an ERV the exhaust air can be used to cool the warmer air being brought in from the outside, reducing the energy consumption load on the air conditioner and the energy associated with air conditioning. With proper design, the size of the air conditioner can be reduced. If buildings tend to be too humid, ERVs can lower humidity levels, reducing the likelihood of mold, bacteria, viruses, and fungi which cause sickness, absenteeism, and lost productivity. On the other hand, in cold dry climates, energy is wasted when warm air from the building is exhausted, plus there can be an additional issue of the incoming air stream being too dry. As well as transferring heat from the exhaust air to the incoming air, ERVs can be used to recycle water vapor from the exhaust stream, raising humidity levels, thereby reducing skin irritation, dryness, and respiratory symptoms caused by dry air.

A key component in the ERV system which transfers the heat and humidity between the air streams is called the ERV core. The two most common types of ERV are those based on planar membrane plate-type devices and those based on rotating enthalpy wheel devices. Planar plate-type ERV cores comprise layers of water permeable membrane. The two air streams are directed through alternate layers, or on opposite sides, of the ERV core, and heat and humidity is transferred via the membrane. Since the air is being exhausted primarily to remove stale and contaminated air from the building, preferably the exhaust stream should not be able to mix with the incoming stream on the opposite side of the membrane as the two streams pass through the ERV. However, in many cases there is crossover contamination (leakage between streams) due to leakage at seals or joints in the ERV and/or due to passage of the gases through the membrane material.

Preferably the membrane used in an ERV core has high moisture vapor transmission rates to minimize the size of the core and ERV unit required. Moisture is driven from one side of the membrane to the other by the vapor pressure differential or water concentration gradient between the two streams. Also, a thin moisture vapor transmission membrane is preferred to allow adequate heat exchange between the two streams, driven by the temperature gradient between the streams. Thinner membranes will tend to have higher heat and moisture transport rates. Ideally the membrane is also impermeable to air, and contaminant gases, to prevent the mixing and crossover of the two streams through the membrane.

Desirable properties of a membrane for enthalpy exchangers, and other applications involving exchange of moisture and optionally heat between gas streams with little or no mixing of the gas streams through the membrane, generally include the following:

High water permeation (vapor and liquid);

High water absorption;

Low or zero air and contaminant gas permeation;

Non-flammable;

Resistance to microbial growth;

Favorable mechanical strength and properties when dry or when wet, so that the membrane is easy to handle, does not tear easily, preferably will accept and hold a pleat, and is stiff enough to withstand pressure differentials so the membrane does not deflect unduly;

Good dimensional stability in the presence of liquid water and washable, allowing cleaning for maintenance purposes without damaging or compromising the functionality of the ERV core;

Long lifetime under the required operating conditions, without detrimental leaching or loss of membrane components and without significant degradation in water vapor transport performance or increased contaminant crossover;

Tolerance to freeze-thaw cycles in the presence of liquid water condensation without significant deterioration in performance;

Low cost; and

Formability, meaning the membrane can be formed into three-dimensional structures and will hold its formed shape.

Often the above represent conflicting requirements. For example, materials which have low air permeability tend to also have low water permeability; polymer films provide excellent handling but tend to be rather flammable; and specialty polymers and highly engineered thin film composites and similar materials tend to be very expensive.

The water vapor transport membranes described herein can provide high water permeance and high selectivity (low gas crossover) making them particularly suitable for ERV applications, and other applications involving exchange of moisture and optionally heat between gas streams. Furthermore, membranes which have similar permeation and selective properties which can also be formed into three-dimensional structures are demonstrated.

### SUMMARY OF THE INVENTION

The invention is directed to pleated composite pervaporation laminate comprising highly selective films and porous supports. Such membranes are particularly suitable for use in enthalpy exchangers and other applications involving exchange of moisture and optionally heat between gas streams, with little or no mixing of the gas streams through the membrane. The invention describes a unique method of making a pleatabed composite pervaporation laminate that incorporates first casting a thin film moisture transfer membrane onto a carrier substrate and then subsequently transferring this thin film moisture transfer membrane onto a porous support layer, and preferably a pleatable porous support layer. By first casting the membrane onto a carrier substrate, which may be non-porous at least on the casting surface, a very thin and consistent layer of the moisture transfer membrane can be produced. The carrier substrate may be a film that does not allow the moisture transfer polymer to penetrate therein, thereby enabling formation of a controlled thickness. The carrier substrate may be a film with no bulk flow of air therethrough. This thin moisture transfer membrane is then transferred onto a porous support layer to produce a composite pervaporation membrane. The composite pervaporation membrane may then be pleated to produce a pleated composite pervaporation cartridge having an increased surface area density, area of the pleated material over the exposed area of the cartridge. For rectangular cartridges, the surface area density is simply the area of the pleated composite pervaporation laminate over the opening area of the cartridge. The surface area density may be 1.5 or more, about 2 or more, about 3 or more, about 5 or more about 10 or more and any range between and including the values provided. This composite pervaporation composite may have a second porous support layer attached to the exposed side of the thin moisture transfer membrane, thereby sandwiching the thin moisture transfer membrane between the two porous support layers. This tri-layer composite pervaporation laminate provides very high moisture vapor transmission and protects the thin moisture transfer membrane from damage during handling and use.

The composite pervaporation laminate may be a pleatable composite pervaporation laminate, that is configured to be pleated to increase the surface area density of a pervaporation cartridge. The pleatable composite pervaporation laminate comprises an ultra-thin, less than 5 μm (micrometers), hydrophilic film laminated on a formable support layer. The thin film moisture transfer membrane can be laminated on one or both sides of the support layer, or between formable support layers. Laminating on both sides reduces or eliminates mixing or crossover of gas streams but preferably, the membrane consists of a support layer with a hydrophilic film less than 2 μm thick laminated on one side to provide highest water permeation rates. It may be preferred to have produce a tri-layer composite pervaporation laminate when the composite pervaporation laminate is subsequently pleated or otherwise formed or shaped for installation or incorporation into a pervaporation unit or cartridge. The thin film moisture transfer membrane will be more effectively protected from damage when configured between support layers. An exemplary method for making the composite pervaporation laminate or pleated composite pervaporation laminate comprises.

a) casting a moisture transfer polymer onto a onto a carrier substrate to produce a thin film moisture transfer membrane;

b) transferring the thin film moisture transfer membrane from the carrier substrate to a pleatable porous support layer by decal transfer process, such as hot pressing;

c) peeling away the carrier substrate to produce a pleatable composite pervaporation laminate; and optionally;

d) optionally attaching a second pleatable porous support layer to the exposed side of the thin film moisture transfer membrane;

d) pleating the composite pervaporation laminate to form a pleated composite pervaporation laminate.

The moisture transfer polymer may be cast onto carrier substrate by solution casting, extrusion, vapor deposition and the like. A very thin film moisture transfer membrane is produced that is bulk gas impermeable, having a Gurley time of more than 100 seconds (Gurley densometer 4340 test). The thin film moisture transfer membrane may be effectively consistent in thickness with a variation of less than 20% and preferably less than 10% over an area of at least 100 cm². This uniform thickness and consistent layer would not be possible by casting onto a porous substrate.

The film moisture transfer membrane can then be transferred to a porous support layer, such as through a decal transfer process. This method of using a carrier substrate eliminates direct handling of the thin film moisture transfer membrane and associated defects. This allows for a thin film of moisture transfer membrane with a thickness about 5 μm or less, about 4 μm or less, about 3 μm or less, about 2 μm or less, about 1 μm or less and any range between and including the thickness values provided. μm and 5 μm to be processed easily using a simple and cost-effective manufacturing process.

The thin film moisture transfer membrane is preferably made from polyether block amide (PEBA) which is a high-performance thermoplastic elastomer. It is used to replace common elastomers, such as thermoplastic polyurethanes, polyester elastomers, and silicones, for these characteristics: lower density among TPE, superior mechanical and dynamic properties (flexibility, impact resistance, energy return, fatigue resistance) and keeping these properties at low temperature (lower than −40° C.), and good resistance against a wide range of chemicals. PEBA is marketed under the PEBAX® and VESTAMID® brands by Arkema Inc and EVONIK Resource Efficiency Gmbh, respectively. Pebax® MH 1657, Pebax® MV 1041, Pebax® MV 1074 and Pebax® MV 3000 are the water permeable PEBA grades offered by Arkema with 1657 being the most water permeable grade. These grades can be easily dissolved in appropriate solvents to obtain a wide range of concentrations for thin film casting.

Other thin film moisture transfer membranes may incorporate an ion transfer membrane or ionomer, such as perfluorosulfonic acid, and the like.

The carrier substrate may be a material that has a non-porous casting surface to enable formation of the thin film moisture transfer membrane. A carrier substrate may be a film of material, such as a film of material comprising a polymeric layer. The polymeric layer have a low surface energy of about 25 dynes/cm or less, about 22 dynes/cm or less, about 20 dynes/cm or less, about 18 dynes/cm or less. A lower surface energy may enable easier release of the thin film moisture transfer membranes from the casting surface. Alternatively, the casting surface may be hydrophilic to enable the moisture transfer polymer solution to wet onto the surface for better spreading and complete coverage of the casting surface by said solution. A casting surface of the carrier substrate may have a surface energy of about 20 dynes/cm or more, about 40 dynes/cm or more, about 60 dynes/cm or more and any range between and including the surface energy values provided. Again, the higher surface tension casting surfaces may be used with aqueous moisture transfer polymer solutions to promote complete coverage and spreading.

A porous support layer is porous and permeable to allow high mass transfer exchange with the thin film moisture transfer membranes. A porous support layer may have a Gurley densometer time of less than 100 seconds, less than 50 seconds, less than 20 seconds, less than about 10 second and any range between and including the Gurley times provided. (as measured on a 4340 Gurley densometer). A porous support layer may be macroporous having pores that are greater than about 10 μm, greater than about 50 μm, or even greater than about 100 μm, and may be open cell foams, non-wovens, wovens and the like. The larger the pore size, the higher the flow therethrough and therefore less resistance for airflow and moisture transport through the porous support layer or layers. A porous support layer may be selected from fiber glass sheets, felts, non-woven or woven polymeric materials such as polystyrene (PS), polyvinyl chloride (PVC), viscose or polyester, such as polyethylene terephthalate (PET), or co-polyester and the like.

A porous support layer may be a pleatable porous support layer that has effectively rigidity to hold a pleated shape. A pleatable porous support layer may have an effective drape stiffness to enable a pleatable composite pervaporation laminate to be self-standing, wherein the pleated pack maintains a pleated shape when retained in a perimeter frame without any additional support.

According to one embodiment of the present invention, the film may contain biocides such as Diiodomethyl p-tolyl sulfone, ZPT (Zinc 2-pyridinethiol-1-oxide), DCOIT (4,5-dichloro-2-n-octyl-3(2H)-isothiazolone), OIT (2-n-octyl-4-isothiazolin-3-one) to inhibit mold formation and kill bacteria.

The film may also have additives that improve the hygroscopicity of the membrane, such as desiccants. Desiccants can be silica based or salt based such as calcium chloride.

### EXAMPLE 1

Pebax® 1657 resin was dissolved in a mixture of water and ethanol to obtain a 5% solution by mass i.e., 1 gram of polymer to 19 grams of solvent. The solution was stirred until homogenous and translucent.

The solution was then applied on a poly(tetrafluoroethylene) carrier substrate using a doctor blade. The final thickness of the film was between 3 μm and 5 μm. It is apparent to those skilled in the art that the film can be formed continuously using roll-to-roll manufacturing.

The film was sandwiched between the carrier substrate and the polyester support during hot pressing at 200° C. and a pressure of 5000 pounds for 5 minutes. The carrier substrate was then peeled away, and the structure shown in FIG. 3 was obtained due to the transfer of the film to the polyester support.

The pleatable composite pervaporation laminate thus obtained was impermeable to air and showed a high permeance of 1.7 gs⁻¹m⁻²Pa⁻¹. The membrane was then corrugated to demonstrate formability.

By using a roll laminator, the film can be continuously hot pressed onto a porous formable support

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a cross sectional view of an exemplary formable porous support layer having pores.

FIG. 2 shows a cross sectional view of an exemplary carrier substrate.

FIG. 3 shows a cross sectional view of an exemplary carrier substrate coated with a moisture transfer polymer solution having a moisture transfer polymer therein.

FIG. 4 shows a cross sectional view of an exemplary carrier substrate coated with a thin film moisture transfer membrane.

FIG. 5 shows a cross sectional view of an exemplary composite pervaporation membrane having a thin film moisture transfer membrane attached to a porous support layer.

FIG. 6 shows a cross sectional view of an exemplary composite pervaporation membrane having a thin film moisture transfer membrane attached between two porous support layers.

FIG. 7 shows a cross sectional view of a pervaporation module having a pleated composite pervaporation laminate configured in a module frame.

FIG. 8 shows a cross sectional view of a pervaporation module having a pleated composite pervaporation laminate configured in a module frame and a cover layer configured over the thin film moisture transfer membrane.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

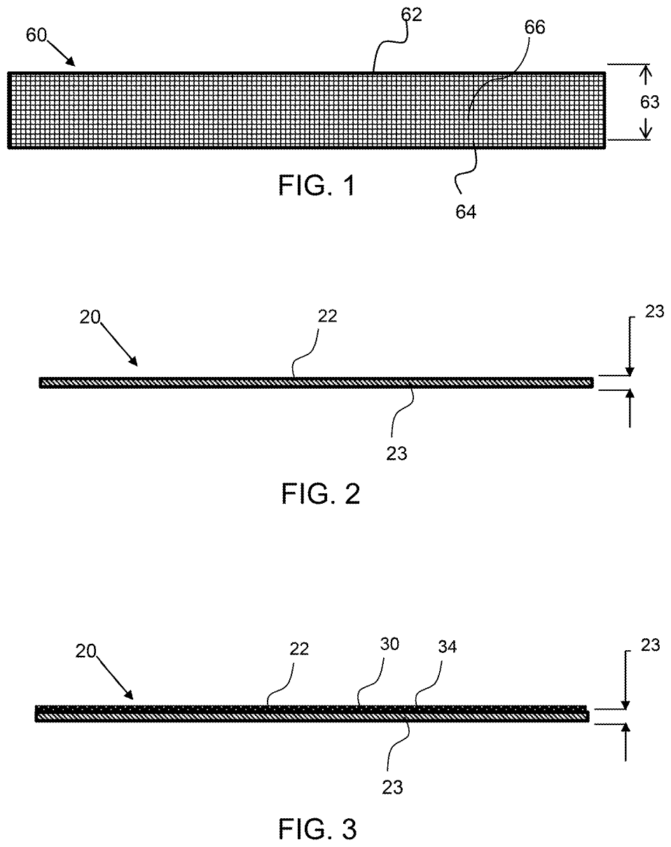

As shown in FIG. 1, an exemplary formable porous support layer 60 has a thickness 63 from a thin film surface 62 to a back surface 64 and pores 66 therein. The pores may be macroscopic pores that are larger than 10 μm.

As shown in FIG. 2, an exemplary carrier substrate 20 has a thickness 23 from a casting surface 22 to a back surface 24.

As shown in FIG. 3, of an exemplary carrier substrate 20 is coated with a moisture transfer polymer solution 30 having a moisture transfer polymer therein 34.

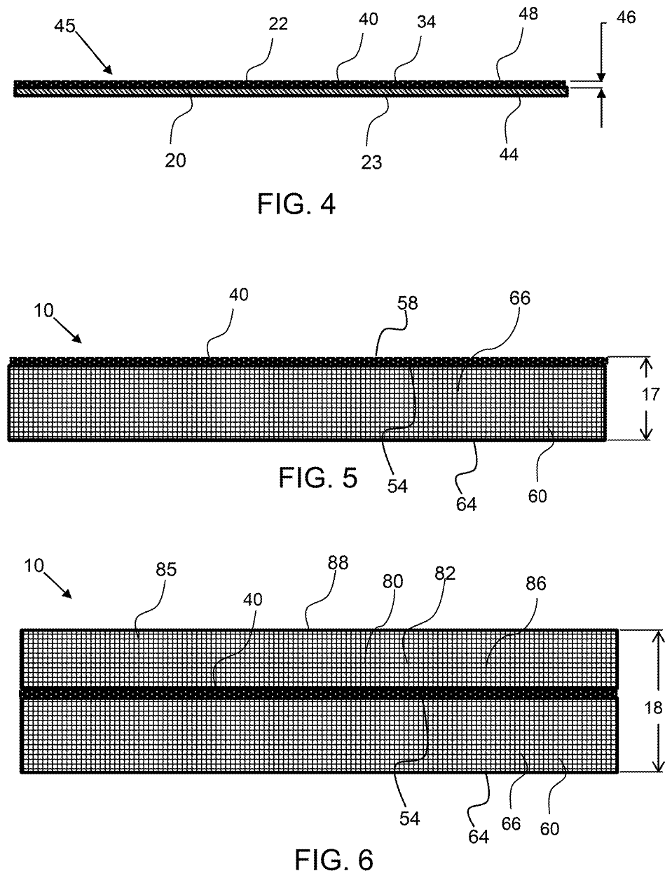

As shown in FIG. 4, the exemplary carrier substrate 20 shown in FIG. 3 now has a thin film moisture transfer membrane 40 configured on the casting surface 22 from the moisture transfer polymer cast thereon. The cast thin film composite 45 includes the thin film moisture transfer moisture transfer membrane 40 on the carrier substrate 20. The thin film moisture transfer membrane 40 has a thickness 46 from a casting surface 44, couple to the carrier substrate 20, to an outside surface 48.

As shown in FIG. 5, an exemplary composite pervaporation laminate 10 has a thin film moisture transfer membrane 40 attached to a porous support layer 60 along an attached surface 54 of the film moisture transfer membrane 40. The composite pervaporation laminate 10 has a thickness 17 from a back surface 64 of the porous support layer 60 to the exposed surface 58 of the thin film moisture transfer membrane 40. The exposed surface 58 may be the casting surface 44 of the thin film moisture transfer membrane 40 after transfer from the carrier substrate to the porous support layer.

As shown in FIG. 6, an exemplary composite pervaporation laminate 10 is a tri-layer composite pervaporation laminate 85, that has a thin film moisture transfer membrane 40 attached between a porous support layer 60 and a cover layer 80, which is also a porous support layer 82 having pores 86. The composite pervaporation laminate 10 has a thickness 18 from a back surface 64 of the porous support layer 60 to the exposed surface 88 of the cover layer 80. The thin film moisture transfer membrane 40 is protected by being sandwiched between the two porous support layers.

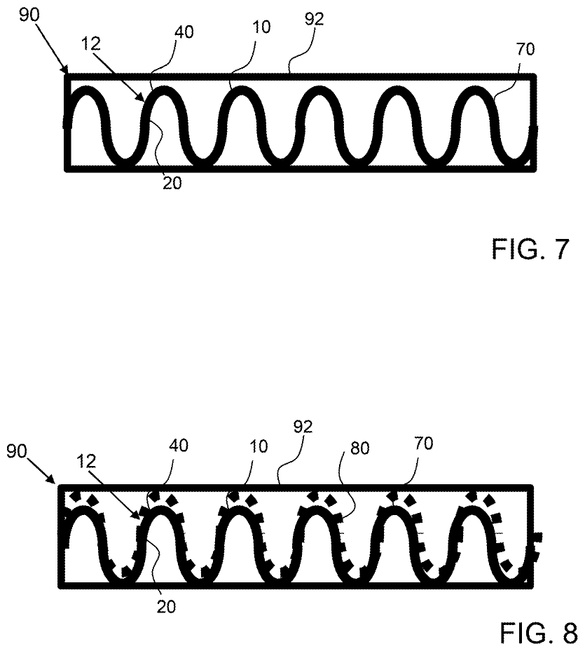

As shown in FIG. 7, a pervaporation module 90 has a pleated composite pervaporation laminate 10 that is a pleated composite pervaporation laminate 12 having the thin film moisture transfer membrane 40 coupled to the porous support layer 20. The pleated composite pervaporation laminate 10 has a plurality of pleats 70 configured in a module frame 92. The pleats 70 enable a high surface area density and the stiffness of the porous support may enable the pleated composite pervaporation laminate to be free standing. The surface area density is increased as the length of the pleated composite pervaporation laminate, when the pleats are flattened out, is much greater than the length of the cartridge.

As shown in FIG. 8, a cover layer 80 may be configured over the thin film moisture transfer membrane 40 to protect the thin film moisture transfer membrane 40 and may be a porous material, such as a non-woven or woven material, such as shown in FIG. 6.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A process for making a composite pervaporation laminate comprising:
a) casting a thin film moisture transfer membrane onto a carrier substrate to produce a cast thin film composite;
b) transferring the thin film moisture transfer membrane of the cast thin film composite to a first porous support layer to produce a composite pervaporation laminate;
wherein the thin film moisture transfer membrane has a thickness of less than 5 micrometers.

2. The process of claim 1, wherein the thin film moisture transfer membrane has a thickness of less than 5 micrometers.

3. The process of claim 1, wherein the thin film moisture transfer membrane has a thickness of less than 3 micrometers.

4. The process of claim 1, wherein the thin film moisture transfer membrane has a thickness of less than 2 micrometers.

5. The process of claim 1, wherein the thin film moisture transfer membrane comprises polyether block amide (PEBA).

6. The process of claim 1, wherein transferring the thin film moisture transfer membrane to a first porous support layer comprises heating and pressing the cast thin film composite to the first porous support layer.

7. The process of claim 1, further comprising pleating the composite pervaporation laminate to form a pleated composite pervaporation laminate having a plurality of pleats.

8. The process of claim 7, wherein the pleated composite pervaporation laminate has a surface area density of at least 1.5.

9. The process of claim 7, wherein the pleated composite pervaporation laminate has a surface area density of at least 3.0.

10. The process of claim 1, further comprising attaching a second porous support layer to the composite pervaporation laminate, opposite the first porous support layer to produce a tri-layer composite pervaporation laminate.

11. The process of claim 10, wherein attaching said second porous support layer comprises pressing and heating the composite pervaporation laminate to the second porous support layer, to produce said tri-layer composite pervaporation laminate.

12. The process of claim 10, further comprising pleating the composite pervaporation laminate to form a pleated composite pervaporation laminate having a plurality of pleats.

13. The process of claim 12, wherein the pleated composite pervaporation laminate has a surface area density of at least 1.5.

14. The process of claim 12, wherein the pleated composite pervaporation laminate has a surface area density of at least 3.0.

15. The process of any of claim 12, wherein the first support layer is a microporous support layer having a pore size of 10 micrometers or more.

16. The process of any of claim 15, wherein the first support layer is porous polyolefin.

17. The process of any of claim 15, wherein the first support layer is porous fluoropolymer.

18. The process of any of claim 12, wherein the second support layer is a macroporous support layer having a pore size of 10 micrometers or more.

19. The process of any of claim 18, wherein the second support layer is porous polyolefin.

20. The process of any of claim 18, wherein the second support layer is porous fluoropolymer.
